(19) United States
(12) Patent Application Publication
(10) Pub. No.: US 2025/0306231 A1
(43) Pub. Date: Oct. 2, 2025

(54) Distributed Airborne Electromagnetic Detection System

(71) Applicants: Xin WU, Beijing (CN); Guoqiang XUE, Beijing (CN); Qingyun DI, Beijing (CN)

(72) Inventors: Xin WU, Beijing (CN); Guoqiang XUE, Beijing (CN); Qingyun DI, Beijing (CN)

(21) Appl. No.: 18/621,108

(22) Filed: Mar. 29, 2024

(51) Int. Cl. G01V 3/16; G01V 3/12

(52) U.S. Cl. CPC G01V 3/16; G01V 3/12

(57) ABSTRACT

The present disclosure discloses a distributed airborne electromagnetic detection system, and relates to an airborne electromagnetic detection technology. The distributed airborne electromagnetic detection system comprises at least one transmitting system, at least one receiving system, at least one trunk module, and an earth station, and also a plurality of Unmanned Aerial Vehicles (UAVs) for carrying the transmitting system, the receiving system, and the trunk module. The distributed airborne electromagnetic detection system does not require high performance or high economical efficiency for a single UAV; under precise synchronous flight conditions, the distance between a type I UAV and a transmitting loop structure can be greatly reduced, thereby significantly reducing the length of unwanted transmitting cable; and in addition, due to the better low-altitude low-speed performance of UAVs, the traveling speed of the entire system can be further reduced, thus obtaining higher quality data.

### TECHNICAL FIELD

The present disclosure relates to the field of geological exploration, and in particular to an airborne electromagnetic detection technology.

### BACKGROUND ART

Electromagnetic methods, which are geophysical prospecting methods based on the electromagnetic induction principle, can use natural or artificial sources to excite the earth and realize the extraction of underground electrical structural information by observing the regularities of temporal and spatial distribution of the earth's response electromagnetic field. Thus, the electromagnetic methods have been widely used in the fields of exploration of resources such as minerals and groundwater, geological mapping, environmental engineering and the like.

The electromagnetic methods are classified into two categories according to the nature of response, namely, a Frequency Domain Electromagnetic Method (FDEM) for studying the relationship between the earth's steady-state response and frequency, and a Time Domain Electromagnetic Method (TDEM) or Transient Electromagnetic Method (TEM) for measuring the earth's transient response after the excitation pulse is turned off. In principle, there is no essential difference between FDEM and TDEM, but in terms of a specific detection technology, the two categories of methods are different and thus suitable for meeting different detection needs.

According to a traditional electromagnetic method, an entire observation system is arranged on the ground. This method, however, may have low detection efficiency in areas such as Gobi, deserts, gullies or dense river networks, and forests, and thus be difficult to achieve rapid large-scale coverage. To this end, researchers have proposed Airborne Electromagnetic methods (AEMs) which can also be classified into a frequency domain electromagnetic method and a time domain electromagnetic method. Compared with an airborne frequency domain system, an Airborne Time Domain Electromagnetic (ATEM) system can usually achieve a larger transmission magnetic moment and a higher spectral resolution, and thus be more adapted to take into account both working efficiency and detection performance under airborne motion conditions. Therefore, the ATEM system has become the main type of AEM detection systems.

A carrying platform for the ATEM system is the fundamental factor that determines the performance of the ATEM system. In the early stages of development of the ATEM technology, there were two solutions based on a fixed-wing aircraft and a helicopter, respectively. However, since helicopters were weaker than fixed-wing aircrafts in loading capacity and power supply at that time, ATEM systems were mostly carried on fixed-wing aircrafts in the middle and late twenty century to form Fixed-wing aircraft-borne TEM (FTEM) systems. FIG. 1 shows a schematic diagram of a fixed-wing aircraft-borne ATEM system, which features that an airframe is used as a basic carrying structure, and an origin of force for carrying a transmitting loop is added at a specific location of the airframe by platform modification, so that the transmitting loop is laid around the airframe; a transmitter is installed in an aircraft cabin and powered by the aircraft, and outputs a transmission waveform to the transmitting loop after the transmission waveform is formed; a sensor for observing the earth's response is installed in a sensor pod which is connected to the airframe via a pod towline; the pod towline is usually a composite cable that includes a tensile cable for simply bearing tension and a data cable for transmitting observation signals, and signals observed by the sensor are transmitted to a receiver mounted in the aircraft cabin through the data cable; and in addition, an automatic winch is further mounted on the airframe to realize the retraction and release of the sensor pod.

The fixed-wing aircrafts have dual advantages in the aspects of carrying capacity and power supply. However, the development of the ATEM technology based on fixed-wing aircraft requires modification of the aircraft and needs a professional team to maintain the system including the aircraft, which is relatively high in cost. In developing countries including China, the density of a navigable airport is limited, and if a measurement area is far from the airport, the round-trip flight will actually limit the application efficiency. On the contrary, a helicopter-borne system does not require modification to the helicopter and therefore does not rely on a special-purpose aircraft. Since 2000, with the changes in conditions of the international airborne geophysical prospecting market and the drastic increase in the carrying capacity and power supply performance of the helicopter, the helicopter has had many advantages over the fixed-wing aircraft, such as good low-altitude and low-speed performance, no dependence on airports when take-off and landing, and relatively low maintenance and curing costs, making the helicopter more suitable as a carrying platform for the ATEM system than the fixed-wing aircraft, so that the HTEM system has gradually replaced the FTEM system.

As shown in FIG. 2, a suspension portion of the HTEM system is basically composed of two portions: an inhaul cable system and a transceiver structure system. The inhaul cable system is an umbrella-shaped system composed of cables for bearing tensile forces, and the transceiver system is composed of a transmitting loop carrying structure, a sensor pod and matching components. The transmitting loop carrying structure is usually constructed with hollow-core plastic pipes, trusses, or high-pressure air columns, and a transmitting loop is laid on the surface thereof or therein; the system generally follows a central loop manner, that is, a sensor is arranged at the center of the transmitting loop; the sensor is installed in the sensor pod which is fixed to the transmitting loop carrying structure through an inhaul cable or a special structural member; the entire transceiver structure is connected to the aircraft through an umbrella-shaped inhaul cable system, and the inhaul cable system provides not only the tensile force to the transceiver structure, but also attachment support for a transmitting cable (from a transmitter inside the aircraft to the transmitting loop carrying structure) and a sensor data line (from an inductive magnetic field sensor to a receiver inside the aircraft). In addition, auxiliary sensors such as an attitude sensor, a satellite navigation system, a (radar and/or laser) altimeter and the like, and related components provided to ensure the aerodynamic performance of the system during flight are usually installed on the transmitting loop carrying structure. Since 2000, several HTEM systems have successively appeared in the world. Although these systems have their own characteristics in specific technical aspects, the basic system composition is not much different from that of the example shown in FIG. 2.

As mentioned above, the carrying platform for the ATEM system is the fundamental factor that determines the performance of the ATEM system. In the early stages of development of the ATEM technology, the performance of a helicopter could not meet requirements, so the main implementation model of an ATEM system was FTEM. After a helicopter can provide sufficient carrying capacity and power supply capacity, the advantages of the helicopter over the fixed-wing aircraft, such as no need for major changes to the aircraft, no dependence on airports when taking off and landing, good low-altitude and low-speed performance, relatively low aircraft support and maintenance requirements, and the like, have shown up, thereby being conducive to significant reduction in system use and possession costs. Therefore, a major solution for ATEM systems at present is to gradually replace FTEM with HTEM.

However, existing HTEM systems have still been limited by the technical performance of the flying platform, and have limitations in the aspects of technologies and applications.

It is difficult for existing systems to carry out deep detection in plateau areas for the following reasons: at present, the respective major HTEM models of the international mainstream HTEM detection service providers basically have peak transmitting magnetic moments of above 0.6 MAm². Based on this magnetic moment of 0.6 MAm², the corresponding entire system has a weight of over 600 kg generally. When a plateau area at an altitude of more than 3500 m is to be detected, helicopters, often used as carrying platforms in plain areas, such as Eurocopter AS350B3 and mainstream general-purpose models of the same class from other companies, can hardly ensure sufficient lift for flight safety. For this reason, there are only two solutions: one is to employ a helicopter with higher loading capacity instead, and the other one is to install a lighter detection system instead. The difficulty of solution 1 is as follows: in many countries, there are few large-load helicopters that provide commercial operations; and even if such large-load helicopters are available, the flight services thereof may be expensive. The difficulty of solution 2 is that installing a lighter system instead will directly result in substantial decrease in the system's transmitting magnetic moment, which makes it difficult to achieve the deep detection.

Even in the plain areas, there exist problems as follows:
1) Because a common HTEM system needs to be powered by an aircraft, a transmitter is generally installed in a rear passenger cabin of the aircraft. The aircraft is far away from the transceiver structure, which means that a transmitting cable, after being led out of the transmitter, has to go through a long distance to reach the transceiver structure. On the one hand, this long distance causes unnecessary line loss of transmission current, and on the other hand, it increases useless system weight.
2) An existing HTEM system uses an umbrella-shaped cable system. Such a system can better ensure the attitude of the transceiver structure when the flight speed is stable. However, when a helicopter alters its flight state or is hit by lateral airstream turbulence, the attitude of the transceiver structure and the relative geometric relationship between the transmitting loop and the sensor are both easy to change significantly and difficult to control. In fact, although existing systems mostly have various attitude sensors installed on the transmitting loop carrying structures, only the attitudes of the transmitting loop carrying structures can be observed, while it is completely impossible to control the attitudes of magnetic field sensors that observe the earth's response.
3) For ATEM observation, a relatively low flight speed can help improve the detection quality of the system. During HTEM detection, in order to ensure the safety, a helicopter generally needs to maintain a flight speed of more than 90 km/h, namely 25 m/s. If the fundamental frequency of transmission is 25 Hz, the distance that the system goes forward in one cycle is 1 m. Because a TEM method usually requires superposition to increase the signal-to-noise ratio, for an acceptable “point”, the number of cycles allowed to take part in superposition may be reduced at a high flight speed of the system, affecting the horizontal resolution of the system.

### SUMMARY OF THE INVENTION

An objective of the present disclosure is to overcome or at least partially solve or alleviate the above problems.

A distributed airborne electromagnetic detection system provided by the present disclosure comprises at least one transmitting system, at least one receiving system, at least one trunk module, and an earth station, and also a plurality of Unmanned Airborne Vehicles (UAVs) for carrying the transmitting system, the receiving system, and the trunk module.

Optionally, the transmitting system comprises at least one airborne transient electromagnetic transmitter, a power module that provides power for the airborne transient electromagnetic transmitter, and a transmitting antenna, and a plurality of UAVs are used as carrying platforms to carry the airborne transient electromagnetic transmitter, the power module and the transmitting antenna, respectively.

Optionally, the transmitting antenna comprises a transmitting loop and a transmitting loop carrying structure for carrying the transmitting loop.

Optionally, the transmitting loop is made of a conductor material which is a soft conductive material or a hard conductive column. Optionally, the transmitting loop carrying structure is in the shape of a polygon formed by splicing a plurality of straight structural members and a plurality of curved structural members.

Optionally, the transmitting loop also serves as the transmitting loop carrying structure when the transmitting loop is made of a hard conductive column.

Optionally, the power module is an independent generator, an independent large-capacity battery pack, or a UVA power output module with a high-power power output function.

Optionally, the power module is connected to the airborne transient electromagnetic transmitter through a power supply cable.

Optionally, the airborne transient electromagnetic transmitter outputs a transmission signal to the transmitting loop through a transmitting cable, and observes an actual transmission signal from the transmitting loop.

Optionally, a transmission signal output cable of the airborne transient electromagnetic transmitter is electrically connected with the transmitting loop through a cable disconnecting device which comprises a tensile connector for automatically disconnecting when tensions at both ends thereof reach a threshold.

Optionally, the airborne transient electromagnetic transmitter sends a real-time status thereof to the trunk module wirelessly, and receives instructions wirelessly through the trunk module.

Optionally, the receiving system comprises at least one receiver, a sensor, and a sensor carrying structure, and a UAV is used as a carrying platform to carry the receiving system.

Optionally, the receiver sends a real-time status thereof to the trunk module wirelessly, and receives instructions through the trunk module wirelessly.

Optionally, the sensor is configured to observe electric or magnetic field response generated by the earth under the excitation of the transmitting system, and transmits an observation result to the receiver through a data cable.

Optionally, the sensor is a total field sensor or a vector sensor.

Optionally, the trunk module is configured to receive the real-time status information sent by the transmitting system and the receiving system, and transmits the real-time status information to the earth station together with information collected by the trunk module itself, and instructions sent by the earth station are sent to the transmitting system and the receiving system through the trunk module.

Optionally, the trunk module is carried by a UAV having a substantially higher flight altitude than other UAVs.

Optionally, the plurality of UAVs detects in a formation flight mode.

Optionally, the distributed airborne electromagnetic detection system further comprises a UVA carrying other non-electromagnetic earth observation sensors.

Optionally, the UAV carrying other non-electromagnetic earth observation sensors may also join in the above-mentioned UAV formation in an appropriate manner to perform formation flight detection together.

In the detection process, in addition to the UAV carrying an airborne trunk communication module, each of the other UAVs carrying the transmitting system and the receiving system performs formation flight according to a preset flight plan, and the relative position relationship among the UAVs remains stable. The UAV carrying the trunk communication module is also launched at the same time, but is required to fly much higher than other UAVs.

In the entire detection process, the UAV carrying the airborne trunk module can travel along with the formation always at a particular height above the center of the transmitting loop, or can always hover at a specified position, or only move within a small space.

The distributed airborne electromagnetic detection system of the present disclosure does not require high performance or high economical efficiency for a single UAV because a plurality of UAVs are used to carry the basic constitutional units, namely the electromagnetic detection system such as the transmitter, the transmitting loop, the receiver and the sensor, respectively. Under precise synchronous flight conditions, the distance between a UAV and a transmitting loop structure can be greatly reduced, thereby significantly reducing the length of unwanted transmitting cable. In addition, due to the better low-altitude low-speed performance of UAVs, the traveling speed of the entire system can be further reduced, so that higher quality data can be obtained. Moreover, the present disclosure also has the advantage that the performance parameters (e.g., magnetic moment and observation) of the carried system can be regulated according to application scenarios and detection requirements, so as to further improve the technical solution of airborne electromagnetic detection.

Based on the following detailed description of specific embodiments of the present disclosure with reference to the accompanying drawings, those skilled in the art will more clearly understand the above-mentioned and other objectives, advantages and features of the present disclosure.

### BRIEF DESCRIPTION OF THE DRAWINGS

Some specific embodiments of the present disclosure will be described in detail below in an exemplary and non-limiting manner with reference to the accompanying drawings.

Like reference numerals in the drawings indicate like or similar components or parts.

Those skilled in the art will appreciate that these drawings are not necessarily drawn to scale.

In the drawings:

FIG. 1 illustrates a fixed-wing aircraft-borne ATEM system in the background art, with 6 representing a transmitting loop, 7 representing a flying platform, and 8 representing a pod cable;

FIG. 2 illustrates a helicopter platform-borne ATEM system in the background art, with 9 representing an inhaul cable system;

FIG. 3 is a schematic diagram of an overall structure of a distributed airborne electromagnetic detection system according to an embodiment of the present disclosure, with 10 representing a survey line;

FIG. 4 is a schematic diagram of a connection structure between a transmitting system and a UAV according to an embodiment of the present disclosure;

FIG. 5 is a schematic structural diagram of a cable disconnecting device according to an embodiment of the present disclosure, with 17 representing an inlet end of a transmitting loop and 18 representing an output end of the transmitting loop; and

FIG. 6 is a schematic diagram of a connection structure between a receiving system and a UAV according to an embodiment of the present disclosure.

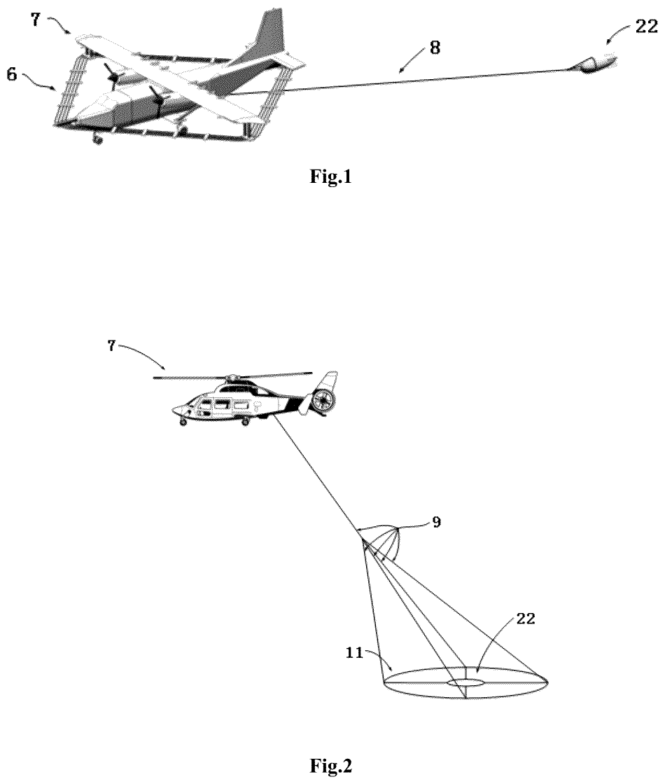

### DETAILED DESCRIPTION OF THE INVENTION

In order to illustrate the objectives, technical solutions and advantages of the present disclosure more clearly, the embodiments of the present disclosure will be described below with reference to the accompanying drawings. It should be noted that, in the case of no conflict, the embodiments in the present disclosure and features in the embodiments can be arbitrarily combined with each other.

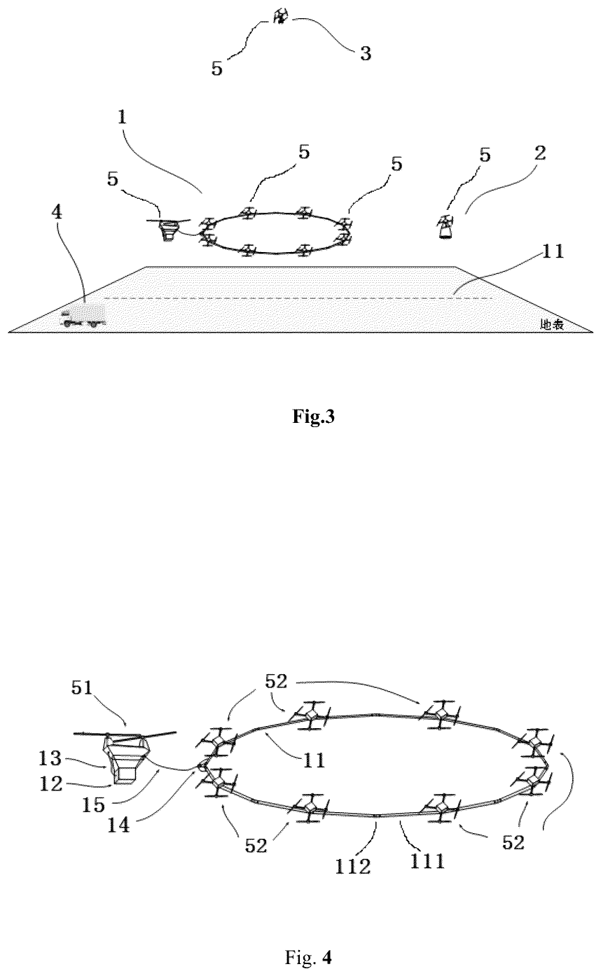

An embodiment of the present disclosure provides a distributed airborne electromagnetic detection system. FIG. 3 is a schematic structural diagram illustrating a distributed airborne electromagnetic detection system according to an embodiment of the present disclosure.

As shown in FIG. 3, the distributed airborne electromagnetic detection system comprises a transmitting system 1, a receiving system 2, a trunk module 3, an earth station 4, and several UAVs 5. The earth station 4 is arranged on the ground, and the transmitting system 1, the receiving system 2 and the trunk module 3 are all carried by the UAVs 5.

The main body of the earth station 4 is constituted by a ground monitoring module of a ground-to-air communication device, and configured to receive status information of the transmitting system 1 and the receiving system 2 that is collected and forwarded by the trunk module 3, as well as image information captured by the trunk module 3 itself, and to display such information in real time. In addition, the earth station 3 is also configured to send instruction information to the trunk module 3, and the instruction information is further forwarded by the trunk module 3 to the transmitting system 1 and the receiving system 2. The trunk module 3 is carried by UAV 5. As shown in FIG. 3, the UAV 5 carrying the trunk module 3 goes forward together with the transmitting system 1 always at a particular height directly above the center of a transmitting loop, thereby overcoming the problem of signal transmission blocking caused by topographic relief.

The transmitting system 1 comprises one airborne transient electromagnetic transmitter, one power module, one transmitting loop, and a transmitting loop carrying structure 11; the components of the transmitting system 1 and an electric generator for supplying power to the airborne transient electromagnetic transmitter are all carried by UAVs 5. Each UAV 5 is powered by a power module which can be an independent electric generator or large-capacity battery pack, or a power output module with a high power output function for UAV. The electric generator is employed in this embodiment.

As shown in FIG. 4, the electric generator is located in an electric generator pod 12 which is connected to the airborne transient electromagnetic transmitter through a power supply cable 13.

The airborne transient electromagnetic transmitter generates a transmission signal according to settings, and observes and records the actual transmission waveform. The airborne transient electromagnetic transmitter can transmit its real-time status wirelessly and receive instructions wirelessly. The airborne transient electromagnetic transmitter can be independent or integrated with an UAV as a function module of the UAV.

The transmitting loop, serving as an output component for exciting the electromagnetic field, is made of a conductor material carried on a dedicated transmitting loop carrying structure 11. The conductor material can be selected from a conductive cable, a conductive strip, or other soft conductive materials, and can also be selected from a rigid conductive column. When the hard conductive material is used, the conductive material itself can also constitute the transmitting loop carrying structure 11, that is, the transmitting loop is integrated with the transmitting loop carrying structure 11.

Taking FIG. 3 and FIG. 4 as examples, there are two types of transmitting loop carrying structures 11: straight and curved. Transmitting loop carrying structures 11 having different areas and different shapes can be formed by using different numbers of straight members 111 and different numbers of curved members 112 with different-degree corners. The transmitting loop carrying structure 11 in FIG. 4 is formed by splicing pipes, and is specifically in the shape of a regular hexagon consisting of 16 straight pipes (i.e., straight members 111) and 16 curved pipes (i.e., curved members 112). For different detection requirements, straight pipes having different lengths and curved pipes having different corners can be selected so as to flexibly form polygonal transmitting loop carrying structures 11 different in size and number of edges by splicing. After the fabrication of the transmitting loop carrying structures 11 is completed, the transmitting loop is threaded through the pipes to realize the carrying of the transmitting loop. After the carrying of the transmitting loop on the transmitting loop carrying structures 11 is completed, the model and the number of UAVs for mounting the carrying structures with the transmitting loop can be determined according to the total weight of the transmitting loop and the carrying structures thereof and the altitude of a working area and by further taking into account of particular redundancy.

The UAVs used to carry the transmitting loop are called type II UAVs 52. The UAVs of this type are only used to provide lift and do not assume the functions of the detection system. Each type II UAV 52 is used to mount the transmitting loop carrying structure at a specified position through an elastic cable. Particular components of the transmitting loop carrying structure 11 can be integrated with the type II UAV 52.

Unlike the type II UAV 52, a type I UAV 51 needs to assume part of the functions of the detection system in addition to providing lift. In FIG. 4, UAV 5 which is used to carry the airborne transient electromagnetic transmitter is type I UAV 51 inside which the airborne transient electromagnetic transmitter is located and with which the airborne transient electromagnetic transmitter is integrated. In the embodiment shown in FIG. 4, an electric generator pod 12 is mounted below the type I UAV 51, and an independent electric generator is installed in the pod to provide power for the airborne transient electromagnetic transmitters inside the type I UAV 51 through the power supply cable 13. The electric generator pod 12 and the type I UAV 51 are connected by a high-strength elastic cable, which helps to eliminate the impact of the electric generator vibration on the type I UAV 51.

A transmitting cable 15 is led in from an airborne transient electromagnetic interface disposed on type I UAV in the form of a composite cable, and connected to a cable disconnecting device 14 rather than directly connected to the cable inside the transmitting loop carrying structure 11, as shown in FIG. 5. The interior of the cable disconnecting device 14 is mainly constituted by a tensile connector. When the tensions at both ends of the connector reach a particular level, the connector will be pulled apart. The purpose of this setting is to avoid the damage of the type I UAVs when the transmitting loop is obstructed by ground obstacles and cannot move forward during flight. The connector is designed with a housing, and is connected to the transmitting loop carrying structure 11 by using a non-tensile cable 16 (having a tensile capacity lower than the breaking tension of the connector) to restrict the swing of the cable disconnecting device 14 to some extent during flight.

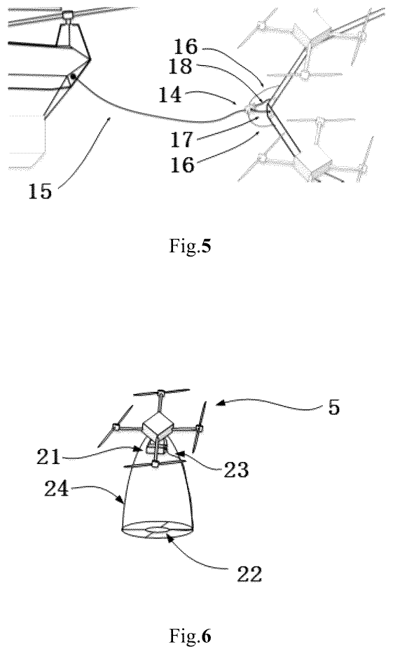

FIG. 6 is a schematic diagram of a connection structure between the receiving system 2 and the UAV 5 in FIG. 3. The receiving system 2 comprises a receiver 21, a sensor pod 22, a data cable 23, and a sensor carrying structure 24, and is carried on a high-power type II UAV. The receiver 21 is configured to record an observation signal output by the sensor. The receiver 21 can transmit its real-time status wirelessly, and receive instructions wirelessly. The receiver 21 may be independent or integrated with the UAV 5, as a function module of the UAV 5. The sensor is configured to observe the electric or magnetic field response of the earth, and can be of simple component or multi-component. The sensor is carried on a dedicated sensor carrying structure 24 which is further carried on the UAV 5.

The communication device system comprises: one airborne trunk communication module and one ground monitoring module. A high-power UAV 2 is used as a carrying platform for the trunk module 3, and the trunk module 3 is configured to receive real-time system status information transmitted by the transmitter and the receiver 21, and transmit such information to the ground monitoring module together with image information captured by the trunk module itself. In addition, the ground monitoring module sends instructions according to the situation, and the instructions are sent to the corresponding transmitter and receiver 21 through the trunk module 3. After the carrying of the transmitting system 1, the receiving system 2 and the airborne trunk module 3 on the UAVs is completed, the formal detection flight phase is started after necessary tests. During the formal detection flight, all UAVs go forward at specified flight altitude and speed according to a specified travel route, ensuring that the geometric relationships among all UAVs in the entire detection system remains highly stable. UAVs carrying other non-electromagnetic earth observation sensors can also join in the above-mentioned UAV formation in an appropriate manner to perform formation flight detection together.

Based on the airborne electromagnetic detection system provided by this embodiment, for plateau detection tasks, the lift of the entire UAV carrying system can be increased by increasing the number of type II UAVs while a large transmitting magnetic moment is maintained, thereby meeting the needs of deep exploration in high altitude areas. The transmitting system is carried by type I UAVs, which will greatly reduce the pressure on the lift supply of type II UAVs carrying the transmitting loop structure. Under precise synchronous flight conditions, the distance between each type I UAV and the transmitting loop structure can be greatly reduced, thereby significantly reducing the length of unwanted transmitting cable. Since the transmitting loop carrying structure is carried by a plurality of type II UAVs, the plane attitude of the transmitting loop can be actively and accurately controlled. In addition, due to the better low-altitude low-speed performance of UAVs, the traveling speed of the entire system can be further reduced, thus obtaining higher quality data.

Although the embodiments disclosed in the present disclosure are as described above, the contents described are only embodiments adopted for facilitating understanding of the present disclosure, and not intended to limit the present disclosure. Any person skilled in the art to which the present disclosure pertains may make any modifications and changes in the form and details of implementation without departing from the spirit and scope disclosed by the present disclosure; however, the scope of patent protection of the present disclosure shall still be subject to the scope defined by the appended claims.

1. A distributed airborne electromagnetic detection system, comprising at least one transmitting system, at least one receiving system, at least one trunk module and an earth station, and also a plurality of Unmanned Airborne Vehicles (UAVs) for carrying the transmitting system, the receiving system, and the trunk module.
The transmitting system comprises at least one airborne transient electromagnetic transmitter, a power module that provides power for the airborne transient electromagnetic transmitter, and a transmitting antenna, and a plurality of UAVs are used as carrying platforms to carry the airborne transient electromagnetic transmitter, the power module and the transmitting antenna, respectively.
The transmitting antenna comprises a transmitting loop and a transmitting loop carrying structure for carrying the transmitting loop.
The transmitting loop is made of a conductor material which is a soft conductor material or a hard conductive column.
The transmitting loop carrying structure is in the shape of a polygon formed by splicing a plurality of straight structural members and a plurality of curved structural members.
The transmitting loop also serves as the transmitting loop carrying structure when the transmitting loop is made of a hard conductive column.

2. The distributed airborne electromagnetic detection system according to claim 1, wherein the power module is an independent generator, an independent large-capacity battery pack, or a UVA power output module with a high-power power output function.

3. The distributed airborne electromagnetic detection system according to claim 1, wherein the power module is connected to the airborne transient electromagnetic transmitter through a power supply cable.

4. The distributed airborne electromagnetic detection system according to claim 1, wherein the airborne transient electromagnetic transmitter outputs a transmission signal to the transmitting loop through a transmitting cable, and observes an actual transmission signal from the transmitting loop.

5. The distributed airborne electromagnetic detection system according to any one of claim 1, wherein a transmission signal output cable of the airborne transient electromagnetic transmitter is electrically connected with the transmitting loop through a cable disconnecting device which comprises a tensile connector for automatically disconnecting when tensions at both ends thereof reach a threshold.

6. The distributed airborne electromagnetic detection system according to claim 1, wherein the airborne transient electromagnetic transmitter sends a real-time status thereof to the trunk module wirelessly, and receives instructions wirelessly through the trunk module.

7. The distributed airborne electromagnetic detection system according to claim 1, wherein the receiving system comprises at least one receiver, a sensor, and a sensor carrying structure, and a UAV is used as a carrying platform to carry the receiving system.

8. The distributed airborne electromagnetic detection system according to claim 1, wherein the receiver sends a real-time status thereof to the trunk module wirelessly, and receives instructions through the trunk module wirelessly.

9. The distributed airborne electromagnetic detection system according to claim 1, wherein the sensor is configured to observe electric or magnetic field response generated by the earth under the excitation of the transmitting system, and transmits an observation result to the receiver through a data cable.

10. The distributed airborne electromagnetic detection system according to claim 1, wherein the sensor is a total field sensor or a vector sensor.

11. The distributed airborne electromagnetic detection system according to claim 1, wherein the trunk module is configured to receive the real-time status information sent by the transmitting system and the receiving system, and transmits the real-time status information to the earth station together with information collected by the trunk module itself, and instructions sent by the earth station are sent to the transmitting system and the receiving system through the trunk module.

12. The distributed airborne electromagnetic detection system according to claim 1, wherein the trunk module is carried by a UAV having a substantially higher flight altitude than other UAVs.

13. The distributed airborne electromagnetic detection system according to claim 1, wherein the plurality of UAVs perform detection in a formation flight mode.

14. The distributed airborne electromagnetic detection system according to claim 1, further comprising a UVA carrying other non-electromagnetic earth observation sensors.
